(19) United States
(12) Patent Application Publication
(10) Pub. No.: US 2024/0076232 A1
(43) Pub. Date: Mar. 7, 2024

(54) ULTRATHIN GLASSES WITH HIGH EDGE IMPACT RESISTANCE

(71) Applicants: SCHOTT AG, Mainz (DE); SCHOTT Glass Technologies (Suzhou) Co. Ltd., Suzhou (CN)

(72) Inventors: Wei Xiao, Suzhou (CN); Ning Da, Suzhou (CN); Feng He, Suzhou (CN); Volker Seibert, Mainz (DE)

(73) Assignees: SCHOTT AG, Mainz (DE); SCHOTT Glass Technologies (Suzhou) Co. Ltd., Suzhou (CN)

(21) Appl. No.: 18/502,475

(22) Filed: Nov. 6, 2023

Related U.S. Application Data
(63) Continuation of application No. PCT/CN2021/091928, filed on May 6, 2021.

(51) Int. Cl. C03C 21/00; C03C 3/083; C03C 3/085; C03C 3/087; C03C 3/091; C03C 3/093; C03C 3/097; C03C 15/00; C03C 17/32

(52) U.S. Cl. CPC C03C 21/002; C03C 3/083; C03C 3/085; C03C 3/087; C03C 3/091; C03C 3/093; C03C 3/097; C03C 15/00; C03C 17/32

(57) ABSTRACT

Chemically toughened glass articles are provided that include a first compressive stress region extending from a first surface, a second compressive stress region extending from a second surface, and a chamfer structure at an edge, which connects the first and second surfaces. The first compressive stress region has a first compressive stress of 100 to 2000 MPa and a first 60% depth (F60D). The second compressive stress region has a second compressive stress of from 100 to 2000 MPa and a second 60% depth (S60D). The chamfered structure has a first ratio of average chamfer height (H_{avg}) to a total chamfer height variation (TCHV) that is at least 250 μm².

### CROSS REFERENCE TO RELATED APPLICATIONS

This application is a continuation of International Application PCT/CN2021/091928 filed May 6, 2021, the entire contents of which are incorporated herein by reference.

### BACKGROUND

### 1. Field of the Invention

The present invention relates to chemically toughened ultrathin glasses with high edge impact resistance. The invention also relates to methods of producing such glasses and to composites comprising such glasses. The invention also relates to use of such ultrathin glasses, in particular as substrate or in a cover of a display, in fragile sensors, fingerprint sensor modules or thin film batteries, semiconductor packages or foldable displays.

### 2. Description of Related Art

Glass is gradually becoming the main choice of cover material for consumer devices, such as smartphone, notebook, TV, etc., due to its high hardness, excellent transmission, high toughness and so on. Recently, as technology develops, the flexible version of these consumer devices are quickly gaining popularity. These flexible electronic devices generally require flexible covers and flexible substrates for protecting and holding electronic components.

Metal foils have some advantages including thermal stability and chemical resistance, but suffer from high cost and a lack of optical transparency. Polymeric foils have some advantages including resistance to catastrophic failure, but suffer from marginal optical transparency, lack of thermal stability and fatigue resistance. Optical transparency and thermal stability are often important properties for flexible display applications.

Due to the unique properties of being flexible, having a high Young's modulus and being transparent, conventional flexible glass materials offer many of the needed properties for flexible substrate and/or display applications. However, efforts to harness glass materials for these applications have been largely unsuccessful to date. Generally, glass substrates can be manufactured to very low thickness levels (<25 μm) to achieve smaller and smaller bend radii, however, while being highly flexible, impact on the edge during processing and handling could be devastating due to the small thickness. At the same time, thicker glass substrates (>150 μm) can be fabricated with potentially better edge impact resistance, but these substrates suffer from huge bending force and lack of mechanical reliability upon bending to a relatively small radius.

Therefore, it is desirable to provide a glass material with high edge impact resistance, and resistance to failure at small bending radii, targeting for safe processing, easy handling and reliable use in ultrathin flexible substrate and/or display, particularly for flexible electronic device and optical applications.

As the most fascinating property of ultrathin glasses is being flexible, glass processors usually focus a lot on improving the flexural strength to enable a smaller and smaller minimum bending radius without failure. Besides chemical toughening, another common approach to reduce the minimum bending radius without failure could be reducing the ratio of the edge circumference to the whole glass article circumference. Because edges usually go through more processing than the remaining surface and have higher density of defects, reducing the edge circumference could effectively improve the bending performance.

### SUMMARY

In the prior art, edge impact resistance is either ignored or sacrificed for bending performance. In contrast, the present invention is directed to the edge impact resistance of ultrathin glasses. An object of the present invention is to provide an ultrathin glass article with optimized chamfer structure for improved edge impact resistance while maintain or even improve the desired mechanical properties of an ultrathin glass article, e.g. flexibility.

The above objects are solved by the present invention.

In one aspect, the present invention relates to a chemically toughened glass article having a thickness t of from 10 μm to 150 μm, the glass article comprising a first surface and a second surface and at least one edge connecting the first surface and the second surface, wherein first and second surface are essentially parallel to each other such that the angle of a tangent line to the first surface is defined as 0° and the angle of the tangent line to the second surface is defined as 180°, wherein the glass article comprises a first compressive stress region extending from the first surface to a first depth DoL1 in the glass article, and a second compressive stress region extending from the second surface to a second depth DoL2 in the glass article, wherein the depth in the first compressive stress region at which the concentration of ions exchanged into the glass has decreased to 60% as compared to its concentration at the first surface is defined as first 60% depth (F60D), and wherein the depth in the second compressive stress region at which the concentration of ions exchanged into the glass has decreased to 60% as compared to its concentration at the second surface is defined as second 60% depth (S60D), wherein t-(F60D+S60D) is defined as the thickness of the central portion CP of the glass article, wherein the first compressive stress region has a compressive stress at the first surface of from 100 to 2000 MPa, and the second compressive stress region has a compressive stress at the second surface of from 100 to 2000 MPa, wherein the edge has a chamfer structure, wherein the chamfer structure has an averaged chamfer surface with a profile such that the angle αₓᵢ of the tangent line to the averaged chamfer surface at any position xi of the averaged chamfer surface is in a range of from >00 to <180°, wherein the profile of averaged chamfer surface is such that for any segment spanning from position xi to position xj of the averaged chamfer surface and having an absolute value of αₓᵢ-αₓⱼ of at least 90°, the projection of the segment onto a line having an angle of 90° with both the tangent line to the first surface and the tangent line to the second surface has an extent that is at least 25% as compared to the thickness of the central portion CP of the glass article, wherein the chamfer structure has a chamfer height H, defined as the projection of the segment spanning from position xi of the averaged chamfer surface closest to the first surface of the glass article with αₓᵢ=450 to position xj of the averaged chamfer surface closest to the second surface of the glass article with αₓⱼ=1350 onto a line having an angle of 90° with both the tangent line to the first surface and the tangent line to the second surface, wherein a total chamfer height variation TCHV of the chamfer height H in the direction of the length y and/or width z of the glass article is defined as the difference of the maximum chamfer height Hₘₐₓ and the minimum chamfer height Hₘᵢₙ along at least a portion of the length y and/or width z of the article divided by the average chamfer height H_{avg} along said portion of the length y and/or width z of the article, wherein the portion is at least 25% of the length y and/or width z, wherein the ratio (t*H_{avg})/TCHV is at least 250 μm².

The averaged chamfer surface is obtained based on overlapping optical layers of a cross-section of the chamfer surface profile. Respective optical images are shown in FIGS. 6A, 6C, and 6E. In order to obtain such images, the glass article is observed with an optical microscope in transmitted light mode. A 200× magnification is used. The focus is on the top plane so that the edges look very sharp. The glass article is positioned such that the top plane is not tilted. Thus, the top plane is perpendicular to the direction of light. Images of particularly good quality are generally obtained with automatic white balance, automatic brightness and automatic contrast, in particular using Nikon Y-TV55 microscope. An averaged chamfer surface is observed in such images due to the depth of field, which determines the depth of overlapping. Using above described method, the averaged chamfer structure is based on overlapping optical layers over a depth of about 0.5 mm. Preferably, the sample has an extent of at least 1 mm in the direction of the observation so that there is sufficient depth for the overlapping.

In one aspect of the invention, the chamfer structure has a chamfer width W, defined as the distance of a position xk on the averaged chamfer surface to the line having an angle of 90° with both the tangent line to the first surface and the tangent line to the second surface, wherein the distance is measured orthogonal to the respective line having an angle of 90° with both the tangent line to the first surface and the tangent line to the second surface, wherein there is no other position on the averaged chamfer surface having a larger distance to the respective line having an angle of 90° with both the tangent line to the first surface and the tangent line to the second surface measured orthogonal to the respective line having an angle of 90° with both the tangent line to the first surface and the tangent line to the second surface. In one aspect of the invention, the ratio of chamfer width W and average chamfer height H_{avg} may be in a range of from 0.1:1 to 10:1, for example from 1:1 to 10:1, from 2:1 to 7.5:1, from 3:1 to 6:1, or from 3.5:1 to 5:1. The ratio of chamfer width W and average chamfer height H_{avg} may for example be at least 0.1:1, at least 1:1, at least 2:1, at least 3:1, or at least 3.5:1. The ratio of chamfer width W and average chamfer height H_{avg} may for example be at most 10:1, at most 7.5:1, at most 6:1, or at most 5:1.

In one aspect of the present invention, a chemically toughened ultrathin glass article is provided having a thickness t of at most 150 μm, in particular preferably at most 100 μm, in particular more preferably at most 85 μm, most preferably at most 70 μm, at most 60 μm, at most 50 μm, at most 40 μm, at most 30 μm, at most 20 μm, at most 10 μm or within a range having any two of these values as endpoints. For example, the ultrathin glass article may have a thickness t in the range of 10 μm to 150 μm, or from 20 μm to 150 μm, or from 30 μm to 150 μm, or from 40 μm to 150 μm, or from 50 μm to 150 μm, or from 70 μm to 150 μm, or from 85 μm to 150 μm, or from 100 μm to 150 μm, or from 10 μm to 100 μm, or from 10 μm to 85 μm, or from 10 μm to 70 μm, or from 10 μm to 60 μm, or from 10 μm to 50 μm, or from 10 μm to 40 μm, or from 10 μm to 30 μm, or from 10 μm to 20 μm. Particularly preferred, thickness t may be from 25 μm to 100 μm, or from 25 μm to 85 μm, or from 25 μm to 70 μm, or from 25 μm to 60 μm, or from 25 μm to 50 μm, or from 25 μm to 40 μm, or from 25 μm to 30 μm. The thickness t may for example be at least 10 μm, at least 20 μm, at least 30 μm, at least 40 μm, at least 50 μm, at least 70 μm, at least 85 μm, or at least 100 μm.

In one aspect of the invention, the ratio of thickness t and average chamfer height H_{avg} may be in a range of from 1.2:1 to 10:1, for example from 1.3:1 to 7.5:1, from 1.5:1 to 5:1, from 1.75:1 to 4:1 or from 2.0:1 to 3.25:1. The ratio of thickness t and average chamfer height H_{avg} may for example be at least 1.2:1, at least 1.3:1, at least 1.5:1, at least 1.75:1 or at least 2.0:1. The ratio of thickness t and average chamfer height H_{avg} may for example be at most 10:1, at most 7.5:1, at most 5:1, at most 4:1 or at most 3.25:1.

The glass article can be of any size. For example it could be a long ultrathin glass ribbon that is rolled (glass roll) or a single smaller glass part cut out off a glass roll or a separate glass sheet or a single small glass article (like a fingerprint sensor (FPS) or display cover glass) etc. Preferably, the glass article of the invention is a sheet or sheet-like article, in particular an article of rectangular or squared shape having a length y and a width z. Both length y and width z are preferably much larger as compared to the thickness t of the article. For example, length y and/or width z may be at least 1 mm, at least 2 mm, at least 5 mm, at least 10 mm, at least 15 mm, at least 20 mm, at least 25 mm, at least 30 mm, at least 40 mm, or at least 50 mm. For example, length y and/or width z may be at most 500 mm, at most 400 mm, at most 300 mm, at most 200 mm, at most 150 mm, at most 125 mm, at most 100 mm, or at most 70 mm. The ratio of length y and width z may be 1:1 or more. In some embodiments, the glass article may have a notch, in particular for the front camera in smartphone applications.

In one aspect of the present invention, the article preferably has a length y in a range of from 10 mm to 500 mm and/or a width z in a range of from 5 mm to 400 mm, for example a length y and/or a width z in a range of from 10 to 400 mm, from 15 to 300 mm, from 20 to 200 mm, from 25 to 150 mm, from 30 to 125 mm, from 40 to 100 mm, or from 50 to 70 mm. The length y and/or the width z may for example be at least 5 mm, at least 10 mm, at least 15 mm, at least 20 mm, at least 25 mm, at least 30 mm, at least 40 mm, or at least 50 mm. The length y and/or the width z may for example be at most 500 mm, at most 400 mm, at most 300 mm, at most 200 mm, at most 150 mm, at most 125 mm, at most 100 mm, or at most 70 mm.

In one aspect, the glass article of the invention comprises a first surface and a second surface and at least one edge connecting the first surface and the second surface, wherein first and second surface are parallel to each other such that the angle of a tangent line to the first surface is defined as 0° and the angle of the tangent line to the second surface is defined as 180°.

Preferably, the article has exactly one edge connecting first and second surface thereof. Depending on the shape of the article, the edge may have different sides. For example, in case of a sheet or sheet-like article having rectangular or squared shape, the edge has four sides, wherein two opposite sides represent the length y of the article and the remaining two opposite sides represent the width z of the article. The positions connecting two adjacent sides of the edge are generally referred to as corners.

In one aspect, the glass article of the invention is chemically toughened. Thus, the article has been subjected to an ion exchange treatment.

Compressive stress (CS) (also referred to as “Pressure stress” or “surface stress”) is the stress that results from the displacement effect on the glass network through the glass surface after ion exchange, while no deformation occurs in the glass.

“Penetration depth” or “depth of ion exchanged layer” or “ion exchange depth” (“depth of layer” or “depth of ion exchanged layer”, DoL) is the thickness of the glass surface layer in which ion exchange occurs and compressive stress is generated. The compressive stress CS and the penetration depth DoL can be measured optically (in particular by a waveguide mechanism), using the commercially available stress meter FSM6000 (for example company “Luceo Co., Ltd.”, Japan, Tokyo).

When CS is induced on one side or both sides of single glass sheet, to balance the stress according to the 3rd principle of Newton's law, a tension stress must be induced in the center region of glass, and it is called central tension (CT). CT can be calculated from measured CS and DoL values.

Ion exchange means that the glass is hardened or chemically tempered (also called chemically toughened) by ion exchange processes, a process that is well known to the person skilled in the art in the field of glass making and processing. The toughening process may be done by immersing the glass layer into a salt bath which contains monovalent ions to exchange with alkali ions inside the glass. The monovalent ions in the salt bath have radii larger than alkali ions inside the glass. A compressive stress to the glass is built up after ion-exchange due to larger ions squeezing into the glass network. After ion-exchange, the strength and flexibility of glass are significantly improved. In addition, the CS induced by chemical toughening improves the bending properties of the toughened glass layer and increases scratch resistance of the glass layer. The typical salt used for chemical tempering is, for example, K⁺-containing molten salt or mixtures of salts. Optional salt baths for chemical toughening are Na⁺-containing and/or K⁺-containing molten salt baths or mixtures thereof. Optional salts are NaNO₃, KNO₃, NaCl, KCl, Na₂SO₄, K₂SO₄, Na₂CO₃, K₂CO₃, and K₂Si₂O₅. Additives such as NaOH, KOH and other sodium salts or potassium salts are also used to better control the rate of ion exchange for chemical tempering. Ion exchange may for example be done in KNO₃ at temperatures in a range of from 300° C. to 480° C., in particular from 340° C. to 450° C. or from 390° C. to 450° C., for example for a time span of from 30 seconds to 48 hours, in particular for about 20 minutes. Chemical toughening is not limited to a single step. It can include multi steps in one or more salt baths with alkaline metal ions of various concentrations to reach better toughening performance. Thus, the chemically toughened glass layer can be toughened in one step or in the course of several steps, e.g. two steps. Two-step chemical toughening is in particular applied to Li₂O-containing glasses as lithium may be exchanged for both sodium and potassium ions.

In one aspect of the invention, the glass article comprises a first compressive stress region extending from the first surface to a first depth DoL1 in the glass article, and a second compressive stress region extending from the second surface to a second depth DoL2 in the glass article. The depth in the first compressive stress region at which the concentration of ions exchanged into the glass has decreased to 60% as compared to its concentration at the first surface is defined as first 60% depth (F60D), and the depth in the second compressive stress region at which the concentration of ions exchanged into the glass has decreased to 60% as compared to its concentration at the second surface is defined as second 60% depth (S60D).

In one aspect of the present invention, the ratio (F60D+S60D)/t is in a range of from 0.01:1 to 0.5:1, for example from 0.02:1 to 0.25:1, or from 0.05:1 to 0.15:1. If the ratio is too small, then the exchange depth may be too small to protect the glass from a deep scratches. If the ratio is too large, the CS value may drop and the center tension may increase, leading to a higher risk of self-explosion. The ratio (F60D+S60D)/t may for example be at least 0.01:1, at least 0.02:1, or at least 0.05:1. The ratio (F60D+S60D)/t may for example be at most 0.5:1, at most 0.25:1, or at most 0.15:1.

Chemical toughening may be symmetric or asymmetric. For example, the ratio F60D/S60D may be in a range of from 0.8:1 to 1.2:1, such as from 0.9:1 to 1.1:1 or from 0.95:1 to 1.05:1. The ratio F60D/S60D may for example be at least 0.8:1, at least 0.9:1, or at least 0.95:1. The ratio F60D/S60D may for example be at most 1.2:1, at most 1.1:1, or at most 1.05:1. Alternatively, the ratio F60D/S60D may be in a range of from 0.1:1 to <0.8:1 or from >1.2:1 to 10:1, such as for example from 0.2:1 to 0.7:1, from 0.3:1 to 0.6:1, from 1.5:1 to 5:1, or from 2:1 to 3:1. The ratio F60D/S60D may for example be at least 0.1:1, at least 0.2:1, at least 0.3:1, more than 1.2:1, at least 1.5:1, or at least 2:1. The ratio F60D/S60D may for example be at most 10:1, at most 5:1, at most 3:1, less than 0.8:1, at most 0.7:1, or at most 0.6:1. The ratio F60D/S60D may also be lower than 0.1:1 or higher than 10:1.

Likewise, the ratio of the compressive stress at the first surface and the compressive stress at the second surface may be in a range of from 0.8:1 to 1.2:1, such as from 0.9:1 to 1.1:1 or from 0.95:1 to 1.05:1. The ratio of the compressive stress at the first surface and the compressive stress at the second surface may for example be at least 0.8:1, at least 0.9:1, or at least 0.95:1. The ratio of the compressive stress at the first surface and the compressive stress at the second surface may for example be at most 1.2:1, at most 1.1:1, or at most 1.05:1. Alternatively, the ratio of the compressive stress at the first surface and the compressive stress at the second surface may be in a range of from 0.1:1 to <0.8:1 or from >1.2:1 to 10:1, such as for example from 0.2:1 to 0.7:1, from 0.3:1 to 0.6:1, from 1.5:1 to 5:1, or from 2:1 to 3:1. The ratio of the compressive stress at the first surface and the compressive stress at the second surface may for example be at least 0.1:1, at least 0.2:1, at least 0.3:1, more than 1.2:1, at least 1.5:1, or at least 2:1. The ratio of the compressive stress at the first surface and the compressive stress at the second surface may for example be at most 10:1, at most 5:1, at most 3:1, less than 0.8:1, at most 0.7:1, or at most 0.6:1. The ratio of the compressive stress at the first surface and the compressive stress at the second surface may also be lower than 0.1:1 or higher than 10:1.

In one aspect of the invention, the first compressive stress region is defined by a compressive stress at the first surface of from 100 to 2000 MPa, for example from 100 to 1800 MPa, from 100 to 1500 MPa, from 200 to 1200 MPa, from 300 to 1000 MPa, from 400 to 950 MPa, from 500 to 900 MPa, from 550 to 875 MPa, from 600 to 850 MPa, from 650 to 825 MPa, or from 700 to 800 MPa, and/or the second compressive stress region is defined by a compressive stress at the second surface of from 100 to 2000 MPa, for example from 100 to 1800 MPa, from 100 to 1500 MPa, from 200 to 1200 MPa, from 300 to 1000 MPa, from 400 to 950 MPa, from 500 to 900 MPa, from 550 to 875 MPa, from 600 to 850 MPa, from 650 to 825 MPa, or from 700 to 800 MPa. Preferably, the compressive stress at the first surface is in a range from 300 to 1000 MPa, and/or the compressive stress at the second surface is in a range of from 300 to 1000 MPa. The compressive stress at the first surface may for example be at least 100 MPa, at least 200 MPa, at least 300 MPa, at least 400 MPa, at least 500 MPa, at least 550 MPa, at least 600 MPa, at least 650 MPa, or at least 700 MPa. The compressive stress at the first surface may for example be at most 2000 MPa, at most 1800 MPa, at most 1500 MPa, at most 1200 MPa, at most 1000 MPa, at most 950 MPa, at most 900 MPa, at most 875 MPa, at most 850 MPa, at most 825 MPa, or at most 800 MPa. The compressive stress at the second surface may for example be at least 100 MPa, at least 200 MPa, at least 300 MPa, at least 400 MPa, at least 500 MPa, at least 550 MPa, at least 600 MPa, at least 650 MPa, or at least 700 MPa. The compressive stress at the second surface may for example be at most 2000 MPa, at most 1800 MPa, at most 1500 MPa, at most 1200 MPa, at most 1000 MPa, at most 950 MPa, at most 900 MPa, at most 875 MPa, at most 850 MPa, at most 825 MPa, or at most 800 MPa. The compressive stress at the first and/or second surface may for example be at least 100 MPa, at least 200 MPa, at least 300 MPa, at least 400 MPa, at least 500 MPa, at least 550 MPa, at least 600 MPa, at least 650 MPa, or at least 700 MPa. The compressive stress at the first and/or second surface may for example be at most 2000 MPa, at most 1800 MPa, at most 1500 MPa, at most 1200 MPa, at most 1000 MPa, at most 950 MPa, at most 900 MPa, at most 875 MPa, at most 850 MPa, at most 825 MPa, or at most 800 MPa

In one aspect of the invention, the edge has a chamfer structure being directed towards both the first surface and the second surface of the glass article. The chamfer structure has an averaged chamfer surface profile such that the angle αₓᵢ of the tangent line to the averaged chamfer surface at any position xi of the averaged chamfer surface is in a range of from >00 to <180°. The averaged chamfer surface is obtained by averaging, in particular by optical averaging. Preferably, averaging is done using an optical microscope, in particular using Nikon Y-TV55 microscope. In particular, the cross-section of the edge of a glass article can be visualized by an optical microscope, in particular with a magnification of 200×, for example as shown in FIGS. 6A-6F. Because of the depth of field (DOF), several optical layers are overlapping in the microscope image so that the chamfer surface profile is observed as an average over a depth of about 0.5 mm. Preferably, the sample has an extent of at least 1 mm in the direction of the observation so that there is sufficient depth for the overlapping.

In one aspect of the invention, the averaged chamfer surface profile may be such that for any position xi of the averaged chamfer surface there is exactly one angle αₓᵢ of the tangent line to the averaged chamfer surface. For example, the averaged chamfer surface may be described by a continuous function. In another aspect of the invention, more than one angle αₓᵢ may be attributed to one or more positions xi of the averaged chamfer surface, for example to two positions thereof. In particular, the averaged chamfer structure may comprise peaks or corners at a position xi connecting positions xh and xj, wherein the angle αₓₕ of the tangent line to the averaged chamfer surface at a position xh of the averaged chamfer surface differs from the angle αₓⱼ of the tangent line to the averaged chamfer surface at position xj of the averaged chamfer surface by at least 1°, at least 2°, at least 5°, or at least 10°, for example 15° to 80°, 20° to 70°, or 30° to 60°. For example, the angle αₓₕ of the tangent line to the averaged chamfer surface at a position xh of the averaged chamfer surface may be 300 and the angle αₓⱼ of the tangent line to the averaged chamfer surface at position xj of the averaged chamfer surface may be 90°. In such a case there is a rapid change of angles at the position xi that connects positions xh and xj. In fact, any angle from 30° to 90° may be attributed to the angle αₓᵢ of the tangent line to the averaged chamfer surface at the position xi that connects position xh with αₓₕ being 30′ and position xj with angle αₓⱼ being 90°.

In one aspect of the invention, the averaged chamfer surface profile is such that the angle αₓᵢ of the tangent line to the averaged chamfer surface at any position xi of the averaged chamfer surface is different from the angle αₓⱼ of the tangent line to the averaged chamfer surface at any other position xj of the averaged chamfer surface. In other words, the averaged chamfer surface profile may be represented as a strictly monotonous function. However, in another aspect of the present invention, the averaged chamfer surface profile is such that the angle αₓᵢ of the tangent line to the averaged chamfer surface at a position xi of the averaged chamfer surface is the same as the angle αₓⱼ of the tangent line to the averaged chamfer surface at another position xj of the averaged chamfer surface. In one aspect of the present invention, the averaged chamfer surface profile is such that the angle αₓᵢ of the tangent line to the averaged chamfer surface is from >00 to <45°, from >135° to <180°, or from 890 to 910 for at least 90%, more preferably at least 95%, more preferably at least 99%, more preferably at least 99.9% of positions xi of the averaged chamfer surface. In one aspect of the present invention, the averaged chamfer surface profile is such that the angle αₓᵢ of the tangent line to the averaged chamfer surface is from 89° to 91° for at least 5% to 20% of positions xi of the averaged chamfer surface.

In one aspect of the invention, the averaged chamfer surface profile is such that for any segment spanning from position xi to position xj of the averaged chamfer surface and having an absolute value of αₓᵢ-αₓⱼ of at least 90°, the projection of the segment onto a line having an angle of 90° with both the tangent line to the first surface and the tangent line to the second surface has an extent that is at least 25%, for example at least 30%, at least 35%, or at least 40% as compared to the thickness of the central portion CP of the glass article. This is particularly advantageous for further improving the edge impact resistance. As the edge width goes slimmer and sharper, impacts directly on the edge could potentially cause more issues.

According to the present invention, the expression t-(F60D+S60D) is defined as the central portion CP of the glass article. In particular, CP represents the central portion of the glass article in which the concentration of ions exchanged into the glass is less than 60% as compared to its concentration at the corresponding surface. A larger central portion CP generally correlates with ion exchange layers of reduced depth. It is advantageous for the edge impact resistance if a large change in the angle of the tangent line to the averaged chamfer surface (at least 90°) is realized on a larger distance in case the central portion CP is larger because a larger CP is in turn associated with decreased depth of ion exchange. If a large angle change is desired to be realized over a short distance, the thickness of the central portion CP is preferably reduced. Preferably, the ratio of the thickness of the central portion CP and article thickness t is in a range of from 0.5:1 to 0.99:1, for example from 0.75:1 to 0.98:1 or from 0.85:1 to 0.95:1. The ratio of the thickness of the central portion CP and article thickness t may for example be at least 0.5:1, at least 0.75:1, or at least 0.85:1. The ratio of central portion CP and article thickness t may for example be at most 0.99:1, at most 0.98:1, or at most 0.95:1.

The chamfer structure has a chamfer height H, defined as the projection of the segment spanning from position xi of the averaged chamfer surface closest to the first surface of the glass article with αₓᵢ=450 to position xj of the averaged chamfer surface closest to the second surface of the glass article with αₓⱼ=1350 onto a line having an angle of 90° with both the tangent line to the first surface and the tangent line to the second surface.

The chamfer height is preferably determined by optical microscopy, in particular based on microscope images having a direction of view facing the edge of the glass article, in particular as shown schematically in FIGS. 1A and 1B. The chamfer height H can be visually determined as the height H of the chamfer structure based on such microscope images, in particular in transmitted light mode. The magnification may for example be 200×. The focus is on the top plane. The glass article is positioned such that the top plane is not tilted. Thus, the top plane is perpendicular to the direction of light. Images of particularly good quality are generally obtained with automatic white balance, automatic brightness and automatic contrast, in particular using Nikon Y-TV55 microscope.

Notably, the chamfer height H may differ at different positions around the perimeter of the glass article. For example, there may be H(p₁)=H₁ at a position p₁, and H(p₂)=H₂ at a position p₂, with p₁≠p₂ and H₁≠H₂. The local chamfer height LH is defined herein as the average local chamfer height along a portion of the length y and/or width z of the article, wherein said portion has a length of from 300 μm to 600 μm, for example 350 μm or 500 μm. The local chamfer height LH can be determined by optical microscopy, in particular based on microscope images having a direction of view facing the edge of the glass article, in particular as shown schematically in FIGS. 1A and 1B. For example, in such images the boundaries of the chamfer may be fitted with a box of 300 to 600 μm in length, for example 350 μm or 500 μm in length, and the height of the box may be recorded as the local chamfer height LH. The height of the box is chosen such that the top line and the bottom line fit best with the boundaries of the chamfer over the length of the box. Thus, the local chamfer height LH represents an average over the length of the box. Determining the local chamfer height LH as an average along a portion of from 300 to 600 μm, for example along a portion of 350 μm or 500 μm turned out to be particularly advantageous for characterizing the local chamfer height. If this portion is reduced, there is an increased risk of noise in the data. If the portion is increased, there is an increased risk of averaging out relevant chamfer height variations. The local chamfer height LH may for example be determined as an average along a portion of at least 300 μm, or at least 350 μm. The local chamfer height LH may for example be determined as an average along a portion of at most 600 μm, or at most 500 μm.

The total chamfer height variation TCHV of the chamfer height H in the direction of the length y and/or width z of the glass article is defined as the difference of the maximum chamfer height Hₘₐₓ and the minimum chamfer height Hₘᵢₙ along at least a portion of the length y and/or width z of the article divided by the average chamfer height H_{avg} along said portion of the length y and/or width z of the article, wherein the portion is at least 25% of the length y and/or width z.

TCHV=(Hₘₐₓ−Hₘᵢₙ)/H_{avg} (Formula 1)

Preferably, the portion is at least 50% of the length y and/or width z, more preferably at least 75% of the length y and/or the width z, more preferably at least 90% of the length y and/or width z, more preferably at least 99% of the length y and/or width z, more preferably 100% of the length y and/or width z. In one aspect of the invention, the portion is at least 25%, more preferably at least 50%, more preferably at least 75%, more preferably at least 90%, more preferably at least 99%, more preferably 100% of the length y and width z.

In one aspect of the invention, TCHV is at most 0.75, at most 0.70, at most 0.65, at most 0.60, at most 0.55, at most 0.50, at most 0.45, at most 0.40, at most 0.35, at most 0.30, at most 0.25, or at most 0.20. TCHV may for example be 0.05 or more, or 0.10 or more, or 0.15 or more. A low TCHV is advantageous as it is associated with an increased edge impact resistance as disclosed herein.

As described above, the local chamfer height LH is defined herein as the average local chamfer height along a portion of the length y and/or width z of the article, wherein said portion has a length of from 300 μm to 600 μm, for example 350 μm or 500 μm. Preferably, Hₘₐₓ, Hₘᵢₙ and H_{avg} are determined based on respective local chamfer heights LH at different positions of the perimeter of the glass article. In particular, local chamfer heights LH may be determined every 10 mm around the entire perimeter of the glass article. Hₘₐₓ may be defined as the highest LH, Hₘᵢₙ as the lowest LH, and H_{avg} as the mean of all local chamfer heights LH determined around the perimeter of the glass article. In turn, TCHV can be calculated (based on Formula 1) from Hₘₐₓ, Hₘᵢₙ and H_{avg} thus determined.

The corners connecting two adjacent sides of the edge are preferably excluded from determining local chamfer heights LH. For example, determining the local chamfer height every 10 mm preferably gives rise to in total 20 different LH values for a glass article having a length y of 60 mm and a width z of 60 mm if the actual corners of the article are excluded so that measurements are done at length positions of y=10 mm, 20 mm, 30 mm, 40 mm and 50 mm, and at width positions of z=10 mm, 20 mm, 30 mm, 40 mm and 50 mm, respectively (y and z=0 mm and y and z=60 mm are excluded). This resolution of 10 mm turned out to be sufficient for characterizing the chamfer height variations of the glass article. However, if an increased resolution is desired, it is of course possible to determine the local chamfer height LH at more positions around the perimeter of the glass article, for example every 5 mm, every 2 mm, every 1 mm, or every 0.5 mm.

As described above, determining the local chamfer height every 10 mm around the entire perimeter of the glass article gives rise to in total 20 different LH values for a glass article having a length y of 60 mm and a width z of 60 mm if the actual corners of the article are excluded. In such a case, TCHV is determined as the difference of the maximum chamfer height Hₘₐₓ and the minimum chamfer height Hₘᵢₙ along 100% of the length y and width z of the article divided by the average chamfer height H_{avg} along 100% of the length y and width z of the article. The reason is that local chamfer heights LH are determined around the entire perimeter of the glass article and thus along 100% of the length y and width z of the article. Determining local chamfer heights LH around the entire perimeter of the glass article (and thus along 100% of the length y and width z of the article) is often particularly preferred.

However, in embodiments of the invention, the TCHV along particular portions of the length and/or width of the glass article may be particularly relevant. For example, in some cases particular portions of the length and/or width of the glass article are in need of a particularly high edge impact resistance because such portions are exposed to particularly high forces, for example during handling and/or use. Therefore, TCHV of the chamfer height H in the direction of the length y and/or width z of the glass article is not necessarily determined along 100% of the length y and width z of the article. It may well be sufficient to determine TCHV along a portion being at least 25% of the length y and/or width z.

In one aspect of the invention, the ratio (t*H_{avg})/TCHV is at least 250 μm², more preferably at least 500 μm², more preferably at least 750 μm², more preferably at least 1000 μm², more preferably at least 1250 μm², more preferably at least 1500 μm², more preferably at least 1750 μm², more preferably at least 2000 μm², more preferably at least 2250 μm², more preferably at least 2500 μm², for example at least 2750 μm², at least 3000 μm², at least 3500 μm², at least 4000 μm², at least 4500 μm², at least 5000 μm², at least 6000 μm², at least 7000 μm² or at least 8000 μm². In fact, as disclosed herein the respective ratio is a good indicator for the edge impact resistance. The higher the ratio (t*H_{avg})/TCHV is, the better is the edge impact resistance. The ratio (t*H_{avg})/TCHV is also called “ratio R” or simply “R” herein. The ratio R may be below 20000 μm², below 15000 μm² or below 10000 μm².

R=(t*H_{avg})/TCHV (Formula 2)

The edge impact resistance is preferably determined by a pendulum swing test as shown in FIG. 2. A 60*60 mm² glass sample is placed on a piece of porous ceramic with a 2 mm overhang. Vacuum is applied by a 150 mbar max pump to fix the glass sample. Then, the overhung edge of the glass sample is hit vertically by a cylindrical pendulum made of stainless steel having a diameter of 10 mm. The weight of the pendulum is 7.5 g. The swing radius is 20 cm. Starting from a swing angle of 10°, pendulum tests are done every 10 mm for the whole perimeter of the glass article. The tests are repeated with an increase of 5° at the same positions previously tested with the swing angle of 10°, until there is a local edge failure. The last angle used for the pendulum test is defined as the critical pendulum angle (CPA).

The corners connecting two adjacent sides of the edge are preferably excluded from the pendulum swing test. For example, doing the pendulum swing test every 10 mm preferably gives rise to in total 20 different LH values for a glass article having a length y of 60 mm and a width z of 60 mm if the actual corners of the article are excluded so that measurements are done at length positions of y=10 mm, 20 mm, 30 mm, 40 mm and 50 mm, and at width positions of z=10 mm, 20 mm, 30 mm, 40 mm and 50 mm, respectively (y and z=0 mm and y and z=60 mm are excluded).

Preferably, the pendulum swing test is done at the same positions for which the local chamfer height LH has been determined. Preferably, the local chamfer height LH is determined prior to performing the pendulum swing test.

Interestingly, as disclosed herein high values of the ratio R correlate with high values of the critical pendulum angle CPA. As disclosed above, the ratio R is calculated as R=(t*H_{avg})/TCHV according to Formula 2. There is a positive correlation of both the thickness t and the average chamfer height H_{avg} with the edge impact resistance reflected by the increased performance in the pendulum swing test (increased critical pendulum angle CPA with increased product t*H_{avg} as shown in FIG. 4). However, this product alone is unable to explain the performance in the pendulum swing test as observed even though a general trend of increased CPA with increased t*H_{avg} was observed. For example, the CPA of samples having t*H_{avg} of about 800 μm² was generally higher as compared to the CPA of samples having t*H_{avg} of about 400 μm² but lower than t*H_{avg} of samples having t*H_{avg} of about 1900 μm². However, relevant differences of CPA values between samples having highly similar t*H_{avg} cannot be explained. Surprisingly, these differences were attributable to differences in the total chamfer height variation TCHV as disclosed herein. It turned out that a low TCHV contributes to improved edge impact resistance and that high TCHV values are associated with impaired performance in the pendulum swing test. In fact, if the product t*H_{avg} is divided by TCHV to obtain the ratio R, a close correlation of R and CPA can be observed as shown in FIG. 3. In other words, the higher the ratio R is, the better is the performance in pendulum swing test and thus the edge impact resistance of the glass articles of the invention.

Preferably, the glass articles of the invention have a critical pendulum angle CPA of at least 10°, more preferably at least 15°, more preferably at least 20°, more preferably at least 25°, more preferably at least 30°, more preferably at least 35°, more preferably at least 40°, more preferably at least 45°, more preferably at least 50°, more preferably at least 55°, more preferably at least 60°, more preferably at least 65°, more preferably at least 70°, more preferably at least 75°, more preferably at least 800 in a pendulum swing test as described herein, in particular in a pendulum swing test using a stainless steel cylinder having a diameter of 10 mm and a weight of 7.5 g, wherein the swing radius is 20 cm. The critical pendulum angle CPA may for example be 1350 or below, 1200 or below, 1050 or below, or 900 or below.

In one aspect of the invention, the glass article is characterized by an absence of failure when the article is held at a bend radius of 20 mm for 60 minutes, in particular at a temperature of 25° C. and a relative humidity of 40%. Thus, the article of the invention may have excellent bending properties in addition to its excellent edge impact resistance. The bending properties may be determined by the following bending test. In the test, the bending article is placed as a U-shape between two parallel metal plates. The two plates are big enough to cover the whole bending article. Thus, there is no part of the glass article that goes beyond the boundaries of the plates. Then one of the plates moves towards the other one while remaining parallel with a speed of 60 mm/min until the distance of the two plates is about 48 mm and then hold for 60 minutes at a temperature of 25° C. and a relative humidity of 40%. The bending radius R may be calculated from plate distance D and the thickness t of the glass article as R=(D−t)/2.396. Thus, a plate distance of about 48 mm corresponds to a bend radius of about 20 mm in the respective setting. After 60 minutes, the bending article is released from the bending status, and absence of failure is defined as no visible cracks could be found on the glass layer. In case of failure, cracks can easily be noticed with the naked eye since toughened glass breaks in a catastrophic manner.

In one aspect of the present invention, the average chamfer height H_{avg} is in a range of from 35% to 100%, for example from 40% to 95%, from 45% to 90%, or from 50% to 85% as compared to the thickness of the central portion CP of the glass article. It turned out that particularly well edge impact resistance can be achieved if H_{avg} and CP are chosen accordingly. The average chamfer height H_{avg} may for example be at least 35%, at least 40%, at least 45%, or at least 50% as compared to the thickness of the central portion CP of the glass article. The average chamfer height H_{avg} may for example be at most 100%, at most 95%, at most 90%, or at most 85% as compared to the thickness of the central portion CP of the glass article. However, other parameters such as TCHV have a relevant influence on the edge impact resistance as well as described herein.

In one aspect of the invention, the surface roughness Rₐ at the first surface and/or at the second surface is at most 1 nm, in particular for a 2×2 μm² or 10×10 μm² area. The surface roughness Rₐ at the first surface and/or at the second surface may for example be 0.05 nm or more for a 10×10 μm² area.

In one aspect of the invention, the surface roughness Rₐ at the chamfer surface is at most 5 nm, in particular for a 2×2 μm² or 10×10 μm² area.

Average roughness (Rₐ) is a measure of the texture of a surface. It is quantified by the vertical deviations of a real surface from its ideal form. Commonly amplitude parameters characterize the surface based on the vertical deviations of the roughness profile from the mean line. Rₐ is the arithmetic average of the absolute values of these vertical deviations. It can be determined according to DIN EN ISO 4287:2010-07.

In one aspect of the invention, the glass article of the invention has a two-point bending strength of at least 700 MPa, at least 800 MPa, at least 1000 MPa, or at least 1200 MPa.

As described above, a low TCHV is advantageous. In one aspect of the invention, the TCHV is so low that the product of TCHV and t/H_{avg} is at most 1.00, more preferably at most 0.95, more preferably at most 0.90, more preferably at most 0.85, more preferably at most 0.80, more preferably at most 0.75, more preferably at most 0.70, more preferably at most 0.65, more preferably at most 0.60. The product of TCHV and t/H_{avg} may for example be 0.50 or more.

The glass articles of the present invention are not restricted to certain glass compositions. However, some glass compositions are particularly advantageous. In an embodiment, the glass may be a silicate glass, such as alumosilicate glass, lithium-aluminum-silicate glass, or borosilicate glass. The glass may also be soda-lime glass. The glass may contain alkali metal oxides, for example Na₂O, in particular in an amount sufficient to allow chemical tempering.

The glass may comprise the following components, in weight percent: SiO₂ 45.0 to 75.0 wt.-%, B₂O₃ 0 to 5.0 wt.-%, Al₂O₃ 2.5 to 25.0 wt.-%, Li₂O 0 to 10.0 wt.-%, Na₂O 5.0 to 20.0 wt.-%, K₂O 0 to 10.0 wt.-%, MgO 0 to 15.0 wt.-%, CaO 0 to 10.0 wt.-%, BaO 0 to 5.0 wt.-%, ZnO 0 to 5.0 wt.-%, TiO₂ 0 to 2.5 wt.-%, ZrO₂ 0 to 5.0 wt.-%, P₂O₅ 0 to 20.0 wt.-%. In preferred embodiments, the glass consists of the components mentioned in the before-mentioned list to an extent of at least 95.0 wt.-%, more preferably at least 97.0 wt.-%, most preferably at least 99.0 wt.-%.

The terms “X-free” and “free of component X”, respectively, as used herein, preferably refer to a glass, which essentially does not comprise said component X, i.e., such component may be present in the glass at most as an impurity or contamination, however, it is not added to the glass composition as an individual component. This means that the component X is not added in essential amounts. Non-essential amounts according to the present invention are amounts of less than 100 ppm (m/m), preferably less than 50 ppm and more preferably less than 10 ppm. Thereby “X” may refer to any component, such as lead cations or arsenic cations. Preferably, the glasses described herein do essentially not contain any components that are not mentioned in this disclosure.

In an embodiment, the glass may comprise the following components, in weight percent: SiO₂ 45.0 to 72.0 wt.-%, B₂O₃ 0 to 4.7 wt.-%, Al₂O₃ 4.0 to 24.0 wt.-%, Li₂O 0 to 6.0 wt.-%, Na₂O 8.0 to 18.0 wt.-%, K₂O 0 to 8.0 wt.-%, MgO 0 to 10.0 wt.-%, CaO 0 to 3.0 wt.-%, BaO 0 to 2.0 wt.-%, ZnO 0 to 3.0 wt.-%, TiO₂ 0 to 1.0 wt.-%, ZrO₂ 0 to 4.6 wt.-%, P₂O₅ 0 to 15.0 wt.-%.

In an embodiment, the glass may comprise the following components, in weight percent: SiO₂ 51.0 to 65.0 wt.-%, B₂O₃ 0 to 4.7 wt.-%, Al₂O₃ 11.0 to 24.0 wt.-%, Li₂O 0 to 6.0 wt.-%, Na₂O 8.0 to 18.0 wt.-%, K₂O 0 to 8.0 wt.-%, MgO 0 to 5.5 wt.-%, CaO 0 to 1.0 wt.-%, BaO 0 to 1.0 wt.-%, ZnO 0 to 3.0 wt.-%, TiO₂ 0 to 1.0 wt.-%, ZrO₂ 0 to 4.6 wt.-%, P₂O₅ 0 to 10.0 wt.-%.

In an embodiment, the glass may comprise the following components, in weight percent: SiO₂ 45.0 to 72.0 wt.-%, B₂O₃ 0 to 4.7 wt.-%, Al₂O₃ 4.0 to 24.0 wt.-%, Li₂O 0 to 3.0 wt.-%, Na₂O 8.0 to 18.0 wt.-%, K₂O 0 to 8.0 wt.-%, MgO 0 to 5.5 wt.-%, CaO 0 to 1.0 wt.-%, BaO 0 to 2.0 wt.-%, ZnO 0 to 3.0 wt.-%, TiO₂ 0 to 1.0 wt.-%, ZrO₂ 0 to 3.0 wt.-%, P₂O₅ 0 to 15.0 wt.-%.

Lower limits of the amount of SiO₂ may for example be at least 45 wt.-%, at least 51 wt.-%, or at least 55 wt.-%. Upper limits of the amount of SiO₂ may for example be at most 75 wt.-%, at most 72 wt.-%, or at most 65 wt.-%.

Lower limits of the amount of B₂O₃ may for example be at least 0.1 wt.-%, at least 0.2 wt.-%, or at least 0.5 wt.-%. Upper limits of the amount of B₂O₃ may for example be at most 5 wt.-%, at most 2 wt.-%, or at most 1 wt.-%. The glass may for example be free of B₂O₃.

Lower limits of the amount of Al₂O₃ may for example be at least 2.5 wt.-%, at least 4 wt.-%, or at least 11 wt.-%. Upper limits of the amount of Al₂O₃ may for example be at most 25 wt.-%, at most 24 wt.-%, or at most 20 wt.-%.

Lower limits of the amount of Li₂O may for example be at least 0.1 wt.-%, at least 0.2 wt.-%, or at least 0.5 wt.-%. Upper limits of the amount of Li₂O may for example be at most 10 wt.-%, at most 6 wt.-%, or at most 3 wt.-%. The glass may for example be free of Li₂O.

Lower limits of the amount of Na₂O may for example be at least 5 wt.-%, at least 8 wt.-%, or at least 10 wt.-%. Upper limits of the amount of Na₂O may for example be at most 20 wt.-%, at most 18 wt.-%, or at most 16 wt.-%.

Lower limits of the amount of K₂O may for example be at least 0.5 wt.-%, at least 1 wt.-%, or for some variants at least 2 wt.-%. Upper limits of the amount of K₂O may for example be at most 10 wt.-%, at most 8 wt.-%, at most 5 wt.-%, at most 3 wt.-%, or for some variants at most 2 wt.-% or at most 1.5 wt.-%. The glass may for example be free of K₂O.

Lower limits of the amount of MgO may for example be at least 0.5 wt.-%, at least 1 wt.-%, or at least 2 wt.-%. Upper limits of the amount of MgO may for example be at most 15 wt.-%, at most 10 wt.-%, or at most 5.5 wt.-%. The glass may for example be free of MgO.

Lower limits of the amount of CaO may for example be at least 0.1 wt.-%, at least 0.2 wt.-%, or at least 0.5 wt.-%. Upper limits of the amount of CaO may for example be at most 10 wt.-%, at most 3 wt.-%, or at most 1 wt.-%. The glass may for example be free of CaO.

Lower limits of the amount of P₂O₅ may for example be at least 0.1 wt.-%, at least 0.2 wt.-%, or at least 0.5 wt.-%. Upper limits of the amount of P₂O₅ may for example be at most 20 wt.-%, at most 15 wt.-%, or at most 10 wt.-%. The glass may for example be free of P₂O₅.

Lower limits of the amount of BaO may for example be at least 0.1 wt.-%, at least 0.2 wt.-%, or at least 0.5 wt.-%. Upper limits of the amount of BaO may for example be at most 5 wt.-%, at most 2 wt.-%, or at most 1 wt.-%. The glass may for example be free of BaO.

Lower limits of the amount of ZnO may for example be at least 0.1 wt.-%, at least 0.2 wt.-%, or at least 0.5 wt.-%. Upper limits of the amount of ZnO may for example be at most 5 wt.-%, at most 3 wt.-%, or at most 1 wt.-%. The glass may for example be free of ZnO.

Lower limits of the amount of ZrO₂ may for example be at least 0.2 wt.-%, at least 0.5 wt.-%, or at least 1 wt.-%. Upper limits of the amount of ZrO₂ may for example be at most 5 wt.-%, at most 4.6 wt.-%, or at most 3 wt.-%. The glass may for example be free of ZrO₂.

Lower limits of the amount of TiO₂ may for example be at least 0.1 wt.-%, at least 0.2 wt.-%, or at least 0.5 wt.-%. Upper limits of the amount of TiO₂ may for example be at most 2.5 wt.-%, at most 1.5 wt.-%, or at most 1 wt.-%. The glass may for example be free of TiO₂.

Preferably, the glass comprises the following components in the indicated amounts (in wt.-%):

| Component | Proportion (wt.-%) |
|---|---|
| SiO₂ | 45-75 |
| Al₂O₃ | 2.5-25 |
| Li₂O | 0-10 |
| Na₂O | 5-20 |
| K₂O | 0-10 |
| MgO | 0-15 |
| CaO | 0-10 |
| P₂O₅ | 0-20 |
| BaO | 0-5 |
| ZnO | 0-5 |
| ZrO₂ | 0-5 |
| B₂O₃ | 0-5 |
| TiO₂ | 0-2.5 |

An optimized coating layer applied onto the glass substrate, especially the edges, may improve the edge impact resistance while maintain or even improve the desired mechanical properties of an ultrathin glass article, e.g., flexibility.

The edge impact resistance may be further increased by introducing one or more layers of a further material to cover relevant proportions of the edge/chamfer area. In particular, such further material may be advantageous for absorbing impact energy and protecting the edge area, for example by viscoelastic deformation, in particular in case the further material is provided as organic layer(s).

The present invention also relates to a composite comprising a chemically toughened glass article of the invention and a further material attached to the article such that at least 50%, more preferably at least 90%, more preferably 100% of the surface of the chamfer structure are covered by the further material.

In one aspect of the invention, the further material additionally covers at least 0.1%, at least 0.3%, at least 1%, at least 5%, and/or at most 100%, at most 90%, at most 75%, at most 50% of the first surface and/or the second surface of the article.

In one aspect of the invention, the Young's modulus of the further material is at most 10 GPa, at most 7 GPa, at most 6 GPa, at most 5 GPa, at most 4 GPa, at most 3 GPa, at most 2 GPa, and/or at least 100 kPa, at least 200 kPa, at least 300 kPa, at least 400 kPa, at least 500 kPa.

In one aspect of the invention, the further material is a polymer. In one aspect of the invention, the further material is selected from the group consisting of Parylene, thermoplastic polyurethane (TPU), polycarbonate (PC), polyethylene (PE), polypropylene (PP), polysulfone (PS), polyethersulfone (PES), polyetheretherketone (PEEK), polyamide (PA), polyamideimide (PAI), polyimide (PI), poly(methyl methacrylate) (PMMA), polyimethylsiloxane (PDMS), polytetrafluoroethylene (PTFE), elastomer and combinations of two or more thereof. Polymers are particularly advantageous for not influencing the stress distribution during bending. Furthermore, polymers may protect the glass from potential scratches due to handling and/or block water vapor from reacting with the glass network and improve the mechanical properties.

In one aspect of the invention, the further material is an inorganic-organic hybrid polymer material, in particular selected from the group consisting of polysiloxanes and modifications thereof, PMMA with inorganic nanoparticles, epoxy-siloxane hybrids and combinations of two or more thereof.

For protection purpose, the total thickness of the further material is preferred larger, but thick layer of further material could potentially cause shift of neutral plane, transmission issues, and so on. Therefore, the thickness of the further material is preferably limited.

In one aspect of the invention, the thickness of the further material is at least as high as the product of the average chamfer height H_{avg} and the total chamfer height variation TCHV, preferably at least 2*H_{avg}*TCHV, at least 3*H_{avg}*TCHV, at least 4*H_{avg}*TCHV, at least 5*H_{avg}*TCHV, and/or at most 200*H_{avg}*TCHV, at most 150*H_{avg}*TCHV, at most 100*H_{avg}*TCHV, at most 70*H_{avg}*TCHV, at most 50*H_{avg}*TCHV.

In one aspect of the invention, the thickness of the further material covering the first surface and/or the second surface of the article is equal to or smaller than the thickness of the further material covering the surface of the chamfer structure.

The present invention also relates to a method of producing a chemically toughened glass article of the invention, the method comprising the following steps: (a) providing a glass article, (b) providing a chamfer structure, and (c) chemically toughening the article.

Preferably, step b) is performed subsequent to step a) but prior to step c).

According to step a) of the method, a glass article is provided. Step a) may comprise a cutting step. In particular, providing a glass article having a length y and a width z may comprise cutting a glass article having a length larger than y and/or a width larger than z into glass articles having a length y and a width z. Glass articles with a desired length and width may be obtained by cutting a larger article into smaller articles having the desired length and width. Cutting is preferably done using Computerized Numerical Control (CNC) in order to obtain glass articles with precisely defined length and width. Cutting may be done to individual glass articles or to stacks of two or more glass articles, for example five glass articles. Using stacks is advantageous because multiple glass articles may be cut simultaneously. The glass articles in the stack may be laminated to the neighboring glass articles, for example using a glue such as a UV-curable glue. A carrier (for example a carrier glass) may be present at the top and/or at the bottom of the stack.

Step a) of providing the glass article may comprise a grinding step. Grinding may in particular be used for introducing desired variations from the strictly rectangular shape usually obtained after cutting. For example, grinding is advantageous for introducing notches and/or for obtaining rounded corners desired for certain applications. Grinding is preferably done under Computerized Numerical Control (CNC) in order to ensure precise geometries. Grinding may be done to individual glass articles or to stacks of two or more glass articles, for example five glass articles. Using stacks is advantageous because grinding may be applied to multiple glass articles simultaneously. The glass articles in the stack may be laminated to the neighboring glass articles, for example using a glue such as a UV-curable glue. A carrier (for example a carrier glass) may be present at the top and/or at the bottom of the stack. The stack is preferably such that all sides of the edge of all individual glass articles are exposed. This ensures that grinding can reliably be applied to all individual glass articles.

According to step b) of the method, a chamfer structure is provided. A chamfer structure is preferably generated by etching.

A chamfer structure may be generated to individual glass articles or to stacks of two or more glass articles, for example five glass articles. Using stacks is advantageous because a chamfer structure may be generated on multiple glass articles simultaneously.

The glass articles in the stack may be laminated to the neighboring glass articles, for example using a glue such as a UV-curable glue. A carrier (for example a carrier glass) may be present at the top and/or at the bottom of the stack. This may be advantageous for protecting first and/or second surface of the two outer glass articles of the stack from the etchant. The stack is preferably such that all sides of the edge of all individual glass articles are exposed. This ensures that etching can reliably be applied to all individual glass articles.

Etching is done by immersing the glass article or stack of glass articles into the etchant solution. The etching time may for example be from 1 to 120 minutes, from 1 to 60 minutes, from 1 to 30 minutes, or from 1 to 20 minutes such as from 2 to 15 minutes or from 5 to 12 minutes. The etching time may for example be at least 1 minute, at least 2 minutes, at least 5 minutes, or at least 10 minutes. The etching time may for example be at most 120 minutes, at most 60 minutes, at most 30 minutes, at most 20 minutes, at most 15 minutes, or at most 12 minutes. Usually, the lower the thickness of the glass article is, the lower etching time may be chosen.

The etching temperature may for example be from 1° C. to 80° C., or from 20° C. to 50° C. such as from 30° C. to 45° C.

The etchant solution preferably comprises or consists of a mixture of HF and/or NH₄HF₂ with an inorganic acid (for example HCl, HNO₃, H₂SO₄ or mixtures of two or more thereof) and/or with an organic acid (for example acetic acid, citric acid, oxalic acid or mixtures of two or more thereof). The total amount of HF and NH₄HF₂ may for example be in range of from 0.1 wt.-% to 10 wt.-% such as from 0.5 to 5 wt.-% or from 1 to 2 wt.-%. The total amount of HF and NH₄HF₂ may for example be at least 0.1 wt.-%, at least 0.5 wt.-% or at least 1 wt.-%. The total amount of HF and NH₄HF₂ may for example be at most 10 wt.-%, at most 5 wt.-% or at most 2 wt.-%. The weight ratio of the total amount of inorganic acid to the total amount of HF and NH₄HF₂ may for example be in a range of from 0.1:1 to 10:1. The weight ratio of the total amount of organic acid to the total amount of HF and NH₄HF₂ may for example be in a range of from 0.1:1 to 10:1. The etchant solution may for example comprise or consist of 3 wt.-% NH₄HF₂ and 3 wt.-% HNO₃, or the etchant solution may comprise or consist of 2 wt.-% NH₄HF₂, 2 wt.-% HNO3 and 5 wt.-% acetic acid, or the etchant solution may comprise or consist of 1 wt.-% HF and 1 wt.-% HNO₃. The etchant solution may comprise one or more surfactants, for example alkylphenol ethoxylate, or ammonium lauryl sulfate, or mixtures of alkylphenol ethoxylate and ammonium lauryl sulfate.

The article or stack of articles is kept fully immersed in the etchant solution during etching. A particularly low TCHV can be achieved by moving the glass article or the stack of glass articles during etching relative to the etchant solution. For example, the article or stack of articles may be moved linearly in one dimension (for example from side to side of the container containing the etchant solution). The article or stack of articles may also be moved in two dimensions (for example from side to side and up and down) or in all three dimensions, in particular in a three dimensional spiral movement. Particularly low TCHV values can be achieved by additionally or alternatively rotating the article or stack of articles during etching. In particular, an upside-down rotation is advantageous. An upside-down rotation is a rotation in which up portions and bottom portions of the article or stack of articles switch position during rotation so that up portions become down portions and then again up portions and so on. Thus, an upside-down rotation is a rotation around a horizontal rotational axis. It is also possible to use a rotation around a rotational axis that is tilted towards a more vertical position as compared to a strictly horizontal axis, for example tilted by angle of >00 to about 60°. The tilt is preferably less than 450 so that the axis is predominantly horizontal. In any case, it is important to keep the article or stack of articles fully immersed in the etchant solution during etching despite the movement and/or rotation. The article may be moved, or rotated, or both moved and rotated.

It turned out that the moving speed has an influence on the TCHV as well. If the movement is very slow, the effects on TCHV are comparably small. On the other hand, if the moving speed is very high, complex liquid flows may be generated that may in turn impair the etching results. Preferably, the article or the stack of articles is moved with a speed of 1 to 30 mm/s, for example from 3 to 15 mm/s, or from 5 to 10 mm/s. A constant speed is preferred. Regarding rotation of the article or stacks of articles, the rotation interval (the time span of one complete rotation) may advantageously be chosen such that the rotation interval is equal to or less than 50% of the etching time, in particular equal to or less than 25% of the etching time. The rotation interval may for example be equal to or more than 6.25% of the etching time, in particular equal to or more than 12.5% of the etching time.

Another measure that may further improve the TCHV is bubbling the etchant solution with a bubbling gas during the etching step. The bubbling gas may for example be air or any kind of inert or low-active gas, for example nitrogen gas. The bubbling gas may be introduced into the etchant solution through a plurality of holes, the individual holes preferably having a diameter of less than 1 mm so that the resulting bubbles are rather small. The density of holes may for example be at least one hole per cm², at least two holes per cm², at least three holes per cm², or at least four holes per cm². The air pressure may for example be from 0.01 to 1 MPa, in particular from 0.05 to 0.5 MPa.

In embodiments of the invention, in which the cutting, grinding and etching steps of the method are all done using stacks of glass articles, the stacks are preferably not delaminated between cutting and grinding, or between grinding and etching. Preferably, there is neither a delamination between cutting and grinding nor between grinding and etching.

However, the stack is usually delaminated prior to chemical toughening. Thus, chemical toughening is usually done on individual glass articles, not on stacks. How delamination is preferably performed, depends on the glue that was used for preparing the stack. For example, for some types of glue, delamination may be achieved by exposing the stack to increased temperatures, for example by boiling in hot water. For some types of glue, delamination may be achieved by exposure to UV light. For some types of glue, the individual glass articles may simply be peeled of the stack physically.

Chemically toughening a glass article by ion exchange according to step c) of the method is well known to the skilled person as described above. The toughening process may be done by immersing the glass article into a salt bath which contains monovalent ions to exchange with alkali ions inside the glass. The monovalent ions in the salt bath have radii larger than alkali ions inside the glass. A compressive stress to the glass is built up after ion-exchange due to larger ions squeezing into the glass network. After ion-exchange, the strength and flexibility of glass are significantly improved. In addition, the CS induced by chemical toughening improves the bending properties of the toughened glass article and increases scratch resistance of the glass article. The typical salt used for chemical tempering is, for example, K⁺-containing molten salt or mixtures of salts. Optional salt baths for chemical toughening are Na⁺-containing and/or K⁺-containing molten salt baths or mixtures thereof. Optional salts are NaNO₃, KNO₃, NaCl, KCl, Na₂SO₄, K₂SO₄, Na₂CO₃, K₂CO₃, and K₂Si₂O₅. Additives such as NaOH, KOH and other sodium salts or potassium salts are also used to better control the rate of ion exchange for chemical tempering. Ion exchange may for example be done in KNO₃ at temperatures in a range of from 300° C. to 480° C. or from 340° C. to 480° C., in particular from 340° C. to 450° C. or from 390° C. to 450° C., for example for a time span of from 30 seconds to 48 hours, in particular for about 20 minutes. Chemical toughening is not limited to a single step. It can include multi steps in one or more salt baths with alkaline metal ions of various concentrations to reach better toughening performance. Thus, the chemically toughened glass article can be toughened in one step or in the course of several steps, e.g. two steps. Two-step chemical toughening is in particular applied to Li₂O-containing glasses as lithium may be exchanged for both sodium and potassium ions.

The present invention also relates to a method of producing the composite of the invention, the method comprising the step of applying the further material to the chemically toughened glass article, wherein the further material is applied by CVD, PVD, slot die, roll-to-roll micro-gravure, spin coating, dip coating, or manually with a brush or rollers.

The further material may be applied to individual glass articles or to stacks of glass articles. Stacks of glass articles are preferably obtained by stacking at least two glass articles on each other such that all sides of the edge of the individual glass articles are exposed.

The present invention also relates to the use of a chemically toughened glass article of the invention or a composite of the invention as substrate or in a cover of a display, in fragile sensors, fingerprint sensor modules or thin film batteries, semiconductor packages or foldable displays.

### BRIEF DESCRIPTION OF THE FIGURES

FIGS. 1A and 1B illustrate a local chamfer height determination process according to the present disclosure;

FIG. 2 shows a pendulum swing test according to the present disclosure;

FIGS. 3 and 4 show graphs of pendulum swing test results according to the present disclosure.

FIG. 5 shows a schematic illustration of a composite according to the present disclosure.

FIGS. 6A-6F show microscope images of representative samples according to the present disclosure.

FIG. 7 shows results of a critical pendulum angle (CPA) according to the present disclosure.

FIG. 8 is a schematic representation of a chemically toughened glass article according to the present disclosure.

### DETAILED DESCRIPTION

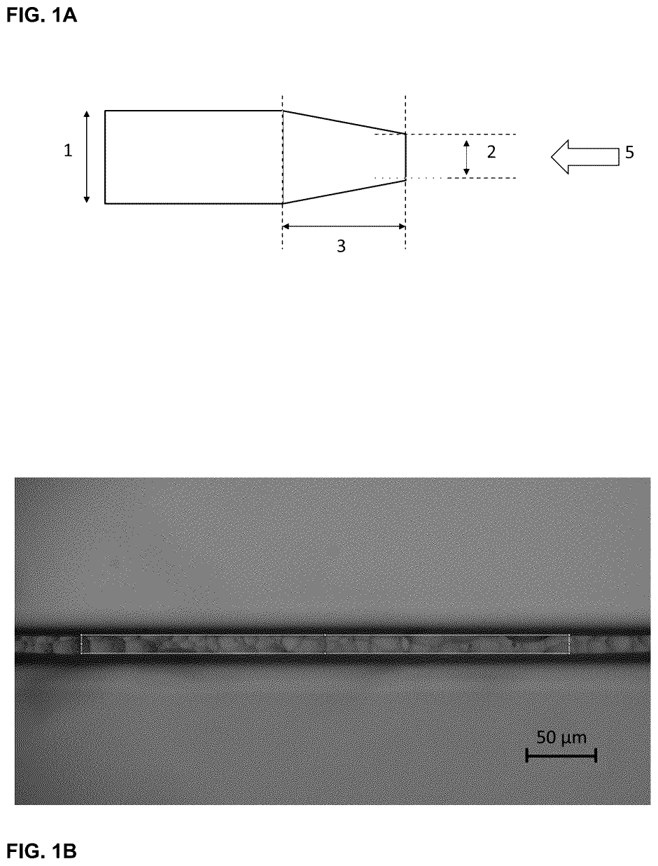

FIGS. 1A and 1B illustrate a preferred way of determining the local chamfer height LH. FIG. 1A shows a schematic representation of a chemically toughened glass article of the invention. The article has a thickness 1 and a chamfer structure having a chamfer height 2 and a chamfer width 3. As shown schematically in FIG. 1A, the local chamfer height LH is determined by optical microscopy based on microscope images having a direction of view facing the edge of the glass article. The direction of view is indicated by arrow 5. FIG. 1B shows a microscope image in transmitted light mode obtained as illustrated in FIG. 1A and having a magnification of 200×. The focus was on the top plane. The glass article was positioned such that the top plane was not tilted. Thus, the top plane was perpendicular to the direction of light. The image was taken with automatic white balance, automatic brightness and automatic contrast using Nikon Y-TV55 microscope. As shown in FIG. 1B, the boundaries of the chamfer have been fitted with a box of 350 μm in length. The height of the box was recorded as the local chamfer height LH. A local chamfer height LH of 13.6 μm was obtained based on the microscope image shown in FIG. 1B.

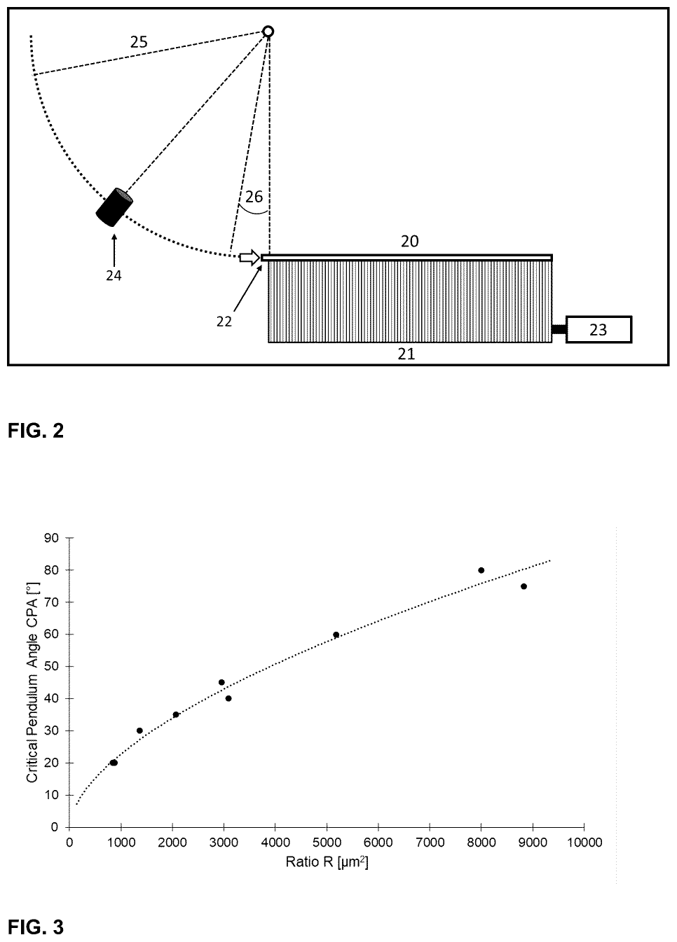

FIG. 2 shows the setup as used in the pendulum swing test for determining the edge impact resistance in terms of the critical pendulum angle (CPA). A 60*60 mm² glass sample (reference sign 20) was placed on a piece of porous ceramic (reference sign 21) with a 2 mm overhang (reference sign 22). Vacuum was applied by a 150 mbar max pump (reference sign 23) to fix the glass sample. Then, the overhung edge of the glass sample was hit vertically by a cylindrical pendulum (reference sign 24) made of stainless steel having a diameter of 10 mm. The weight of the pendulum was 7.5 g. The swing radius (reference sign 25) was 20 cm. Starting from a swing angle of 10° (reference sign 26), pendulum tests were done every 10 mm for the whole perimeter of the glass article. The tests were repeated with an increase of 5° at the same positions previously tested with the swing angle of 10°, until there was a local edge failure. The last angle used for the pendulum test is defined as the critical pendulum angle (CPA).

FIG. 3 summarizes the results of the pendulum swing test as a graph showing the dependence of the critical pendulum angle (CPA) on the y-axis from the ratio R (determined according to Formula 2) on the x-axis. The data obtained in the pendulum swing test have been fitted using the xls-software (Microsoft). The obtained fit is shown as dotted line. It turned out that the critical pendulum angle CPA is roughly proportional to the square root of the ratio R.

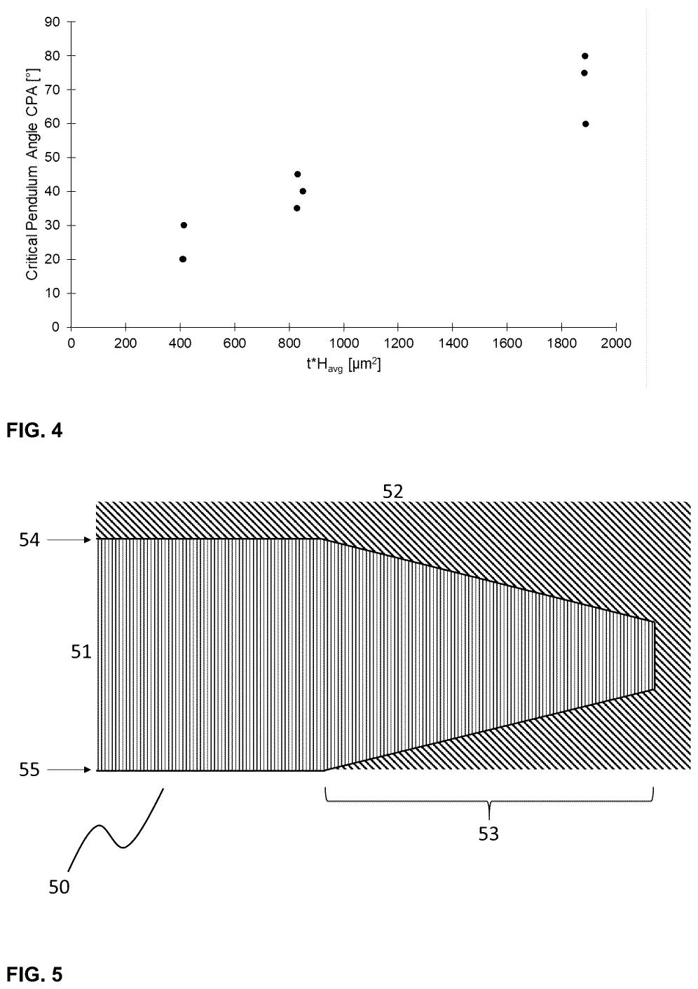

FIG. 4 shows another representation of the results of the pendulum swing test. The critical pendulum angle CPA is shown on the y-axis. The x-axis shows the product of thickness t and average chamfer height H_{avg}. It can be seen that the critical pendulum angle CPA varies remarkably for samples having highly similar values for t*H_{avg}.

FIG. 5 shows a schematic illustration of a composite 50 of the present invention comprising a chemically toughened glass article 51 and a further material 52 attached to the article 51. The further material 52 may be a polymer material 52. The surface of the chamfer structure 53 is covered by a polymer material 52. The first surface 54 of the glass article 51 is covered by the polymer material 52 as well. The second surface 55 of the glass article 51 is free of the polymer material 52.

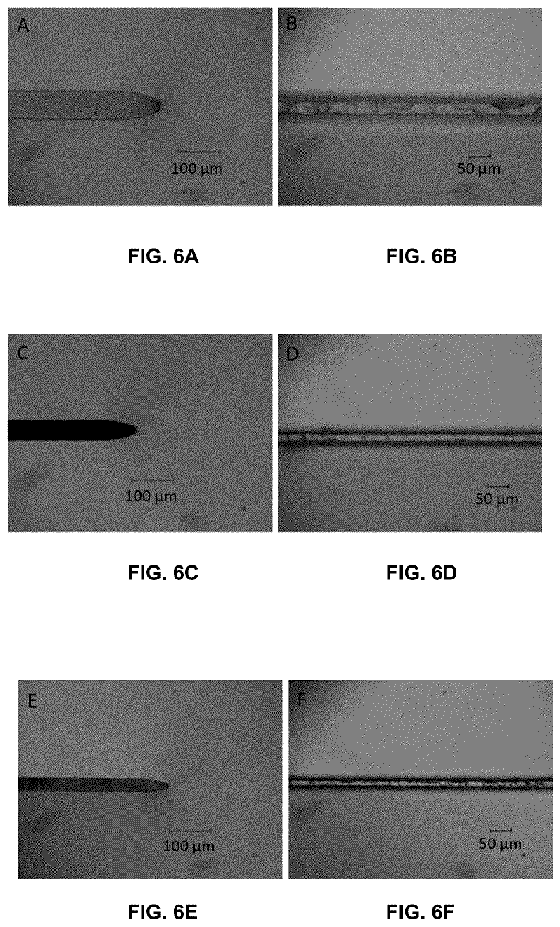

FIGS. 6A-6F show microscope images in transmitted light mode of representative samples of Example A (FIGS. 6A and 6B), Example B (FIGS. 6C and 6D) and Example C (FIGS. 6E and 6F) of the invention. All images have a magnification of 200×. The focus was on the top plane so that the edges look very sharp. The glass article was positioned such that the top plane is not tilted. Thus, the top plane was perpendicular to the direction of light. The images were obtained with automatic white balance, automatic brightness and automatic contrast using Nikon Y-TV55 microscope. FIGS. 6A, 6C and 6E show cross-sections of a chamfer structure on an edge of glass articles of Examples A, B and C, respectively. Because of the depth of field, several optical layers are overlapping in the microscope image over a depth of about 0.5 mm so that the chamfer surface profile is observed as an averaged chamfer surface. FIGS. 6B, 6D and 6F are microscope images having a direction of view facing the edge of the glass articles of examples A, B and C, respectively. Such images can be used for determining the local chamfer height LH as described with respect to FIGS. 1A and 1B.

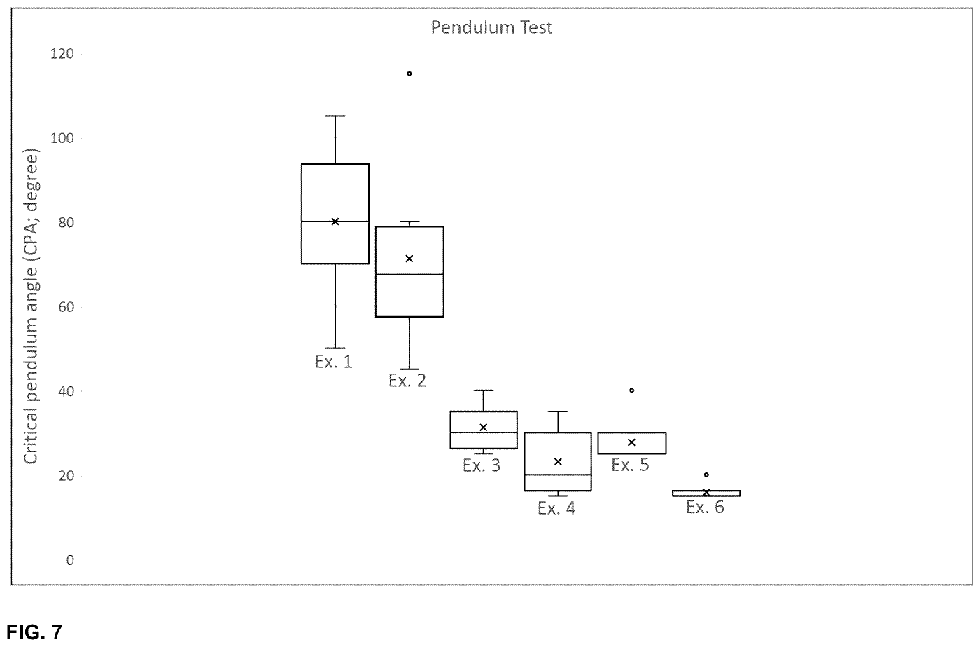

FIG. 7 shows the results (critical pendulum angle (CPA)) of Examples 1 to 6 in the pendulum swing test as a box plot. The boxes are drawn from the first quartile (Q₁/25th percentile) to the third quartile (Q₃/75th percentile) with a horizontal line drawn within the box to denote the median (Q₂/50th percentile). The whiskers show the minimum (lowest data point excluding outliers) and the maximum (largest data point excluding outliers). Upper outliers are defined as values exceeding the value of the third quartile by more than 1.5 times the distance between the values of the third quartile and the first quartile. Lower outliers are defined as values being more than 1.5 times the distance between the values of the third quartile and the first quartile below the value of the first quartile. As shown in FIG. 7, there was one upper outlier for Examples 2, 5 and 6, respectively. There were no lower outliers. The “x” indicates the mean value.

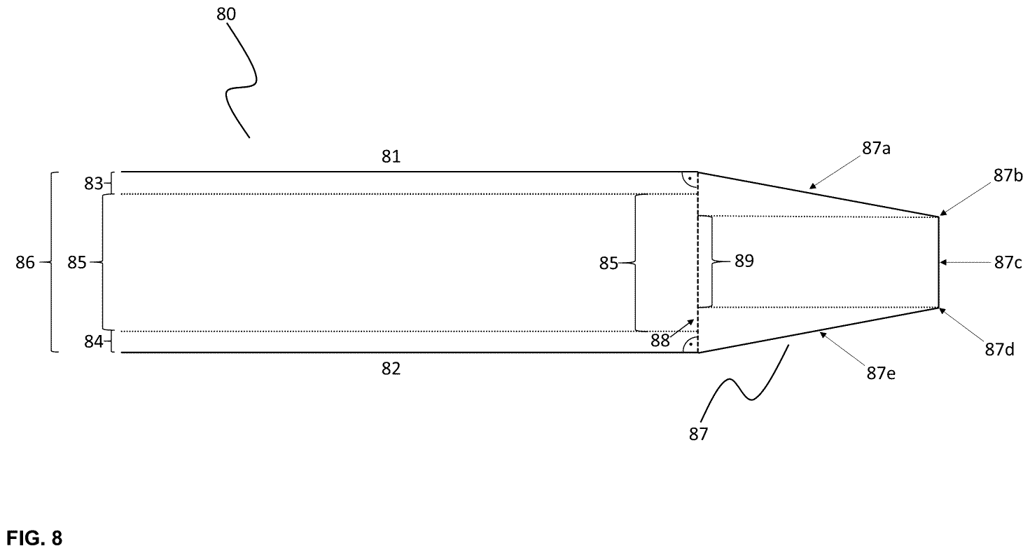

FIG. 8 is a schematic representation a chemically toughened glass article 80 of the present invention. The article has a thickness t as indicated by reference sign 86. The article has a first surface 81 and a second surface 82. First and second surface are essentially parallel to each other. The angle of a tangent line to the first surface 81 may be defined as about 0° and the angle of the tangent line to the second surface 82 may be defined as about 180°. The glass article comprises a first compressive stress region extending from the first surface to a first depth DoL1 in the glass article, and a second compressive stress region extending from the second surface to a second depth DoL2 in the glass article, wherein the depth in the first compressive stress region at which the concentration of ions exchanged into the glass has decreased to 60% as compared to its concentration at the first surface is defined as first 60% depth (F60D, indicated by reference sign 83 in FIG. 8), and wherein the depth in the second compressive stress region at which the concentration of ions exchanged into the glass has decreased to 60% as compared to its concentration at the second surface is defined as second 60% depth (S60D, indicated by reference sign 84 in FIG. 8). The thickness of the central portion CP of the glass article is defined as t-(F60D+S60D) and indicated by reference sign 85 in FIG. 8. There is an edge connecting the first surface and the second surface and the edge has a chamfer structure 87. The chamfer structure 87 has an averaged chamfer surface with a profile such that the angle αₓᵢ of the tangent line to the averaged chamfer surface at any position xi of the averaged chamfer surface is in a range of from >0° to <180°. For example, at a position xa (indicated by arrowhead of reference sign 87a) the angle αₓₐ of the tangent line to the averaged chamfer surface is about 10°. At a position xc (indicated by arrowhead of reference sign 87c) the angle α_{xc} of the tangent line to the averaged chamfer surface is about 90°. At a position xe (arrowhead of reference sign 87e) the angle αₓₑ of the tangent line to the averaged chamfer surface is about 170°. More than one angle α_{xb} and more than one angle α_{xd} may be attributed to positions xb and xd (arrowhead of reference signs 87b and 87d), respectively, of the averaged chamfer surface. In fact, any angle from about >100 to <90° may be attributed to the angle α_{xb} of the tangent line to the averaged chamfer surface at the position xb and any angle from about >900 to <1700 may be attributed to the angle α_{xb} of the tangent line to the averaged chamfer surface at the position xd. A line having an angle of about 900 with both the tangent line to the first surface 81 and the tangent line to the second surface 82 is shown as dashed vertical line 88 in FIG. 8. From position xb to position xd of the averaged chamfer surface there is an absolute value of α_{xb}-α_{xd} of about 170°-10°, i.e., about 160°. The projection of the segment spanning from xb to xd onto the line 88 has an extent 89 that is much more than 25% as compared to the thickness of the central portion CP (reference sign 85) of the glass article. In fact, in the scheme of FIG. 8, the projection of the segment spanning from xb to xd onto line 88 is about 67% as compared to the thickness of the central portion CP (reference sign 85) of the glass article. The chamfer structure has a chamfer height H, defined as the projection of the segment spanning from the position of the averaged chamfer surface closest to the first surface 81 of the glass article with α=450 to the position of the averaged chamfer surface closest to the second surface 82 of the glass article with α=135° onto line 88 having an angle of 90° with both the tangent line to the first surface 81 and the tangent line to the second surface 82. In the scheme of FIG. 8, the chamfer height H corresponds to the projection of the segment spanning from xb to xd onto the line 88. Thus, the chamfer height H has an extent 89.

### Chamfer Surface Profiles

Chemically toughened aluminosilicate glass articles were tested for edge impact resistance using a pendulum swing test. A 60*60 mm² glass sample was placed on a piece of porous ceramic with a 2 mm overhang. Vacuum was applied by a 150 mbar max pump to fix the glass sample. Then, the overhung edge of the glass sample was hit vertically by a cylindrical pendulum made of stainless steel having a diameter of 10 mm. The weight of the pendulum was 7.5 g. The swing radius was 20 cm. Starting from a swing angle of 10°, the tests were repeated with an increase of swing angle of 5° until there was a local edge failure. The last angle used for the pendulum test was defined as the critical pendulum angle (CPA).

In total, 6 different types of articles have been tested. These types of articles are referred to as Examples 1 to 6 in the following and their properties are summarized in the following table. All types of articles were chemically toughened in pure KNO₃ at 390° C. for 20 minutes and had a length y of 60 mm and a width z of 60 mm.

| | Thick- | Average chamfer | | |
|---|---|---|---|---|
| | ness t | height H_{avg} | | Sample preparation |
| Ex. 1 | 70 μm | 30 | μm | Edges ground and chamfer etched to |
| | | | | final profile |
| Ex. 2 | 70 μm | 20 | μm | Edges ground and chamfer etched to |
| | | | | final profile |
| Ex. 3 | 70 μm | 5 | μm | Edges ground and chamfer etched to |
| | | | | final profile |
| Ex. 4 | 70 μm | 1 | μm | Cut from a 400*500*0.33 mm glass |
| | | | | mother sheet by a wheel cutting, then |
| | | | | slimmed to the final thickness by |
| | | | | etching, Edges ground and chamfer |
| | | | | etched to final profile |

| | | | |
|---|---|---|---|
| Ex. 5 | 70 μm | No chamfer | Cut from a 400*500*0.07 mm glass |
| | | structure | mother sheet by diamond wheel |
| | | | cutting |
| Ex. 6 | 70 μm | No chamfer | Cut from a 400*500*0.07 mm glass |
| | | structure | mother sheet by a laser cutting |

The results of the pendulum swing test in terms of critical pendulum angle CPA are shown in FIG. 7.

### Total Chamfer Height Variation TCHV

Chemically toughened glass articles of the invention chemically toughened symmetrically were tested for edge impact resistance using a pendulum swing test. A 60*60 mm² glass sample was placed on a piece of porous ceramic with a 2 mm overhang. Vacuum was applied by a 150 mbar max pump to fix the glass sample. Then, the overhung edge of the glass sample was hit vertically by a cylindrical pendulum made of stainless steel having a diameter of 10 mm. The weight of the pendulum was 7.5 g. The swing radius was 20 cm. Starting from a swing angle of 10°, pendulum tests were done every 10 mm for the whole perimeter of the glass article. For every measurement, a distance of at least 10 mm was kept from the corners of the articles. The measurements were done at positions of 10 mm, 20 mm, 30 mm, 40 mm and 50 mm at each of the four sides of the edge of the article. Positions of 0 mm and 60 mm were excluded.

The tests were repeated with an increase of swing angle of 5° at the same positions previously tested with the swing angle of 10°, until there was a local edge failure. The last angle used for the pendulum test was defined as the critical pendulum angle (CPA).

Articles of three different thicknesses (t=70 μm; t=50 μm; t=30 μm) were tested (referred to as Examples A, B and C, respectively, in the following). For each thickness, three different articles were tested. The three different articles of Example A that have been tested are referred to as samples A1, A2 and A3, respectively. The three different articles of Example B that have been tested are referred to as samples B1, B2 and B3, respectively. The three different articles of Example C that have been tested are referred to as samples C1, C2 and C3, respectively.

The properties of the different Examples A, B and C were as follows.

| | Example A | | Example B | | Example C | |
|---|---|---|---|---|---|---|
| Thickness t | 70 | μm | 50 | μm | 30 | μm |
| Length y | 60 | mm | 60 | mm | 60 | mm |
| Width z | 60 | mm | 60 | mm | 60 | mm |
| Central Portion CP | 61 | μm | 43 | μm | 25 | μm |
| Compressive Stress CS | 600 | MPa | 550 | MPa | 500 | MPa |

All articles had an edge having a chamfer structure having an averaged chamfer profile in line with the present invention. The chamfer structures were generated by etching stacks of glass articles, wherein the glass articles were laminated together using a UV-curable glue. A carrier glass was laminated to each of the two outer glass articles of the stack using the same glue applied for laminating individual glass articles together.

For generating the chamfer structure by etching, the stack was introduced into a container that contained the etchant solution. The stack was introduced into the container such that the stack was fully immersed in the etchant solution. The etching time was 12 minutes for samples A1, A2 and A3, 9 minutes for samples B1, B2 and B3, and 5 minutes for samples C1, C2 and C3. The etching temperature was 40° C. for all samples.

After generation of the chamfer structure, the stacks were delaminated.

Chemical toughening of glass articles was done to achieve the CP and CS values as shown in the table above.

For each sample, the local chamfer height LH was determined along a portion of 350 μm at positions of 10 mm, 20 mm, 30 mm, 40 mm and 50 mm at each of the four sides of the edge of the article based on microscope images having a direction of view facing the edge of the glass article as shown schematically in FIGS. 1A and 1B. The boundaries of the chamfer were fitted with a box of 350 μm in length, and the height of the box was recorded as the local chamfer height LH. Positions of 0 mm and 60 mm were excluded. Thus, five LH values were determined for each of the four sides of the edge. Consequently, 20 LH values were determined in total for each sample. These values are referred to as LH1, LH2, . . . , LH19, LH20 in the following. The results are summarized in the following table. The results are shown in μm. Notably, the local chamfer heights LH were determined prior to performing the pendulum swing test.

| | Ex. | Ex. | Ex. | Ex. | Ex. | Ex. | Ex. | Ex. | Ex. |
|---|---|---|---|---|---|---|---|---|---|
| | A1 | A2 | A3 | B1 | B2 | B3 | C1 | C2 | C3 |
| LH1 | 28.2 | 25.8 | 26.7 | 18.0 | 16.5 | 17.6 | 14.1 | 16.7 | 15.3 |
| LH2 | 25.4 | 26.9 | 26.3 | 16.2 | 16.5 | 17.1 | 12.7 | 12.2 | 13.6 |
| LH3 | 27.4 | 27.1 | 27.1 | 16.3 | 16.9 | 17.0 | 13.9 | 14.6 | 14.8 |
| LH4 | 28.1 | 27.9 | 28.0 | 17.2 | 17.4 | 17.2 | 15.7 | 15.1 | 14.0 |
| LH5 | 27.1 | 25.8 | 26.7 | 18.8 | 17.4 | 16.4 | 14.3 | 12.3 | 13.6 |
| LH6 | 21.9 | 24.0 | 23.7 | 16.0 | 17.8 | 18.3 | 15.5 | 13.2 | 14.0 |
| LH7 | 24.9 | 25.2 | 25.8 | 19.2 | 18.6 | 17.5 | 13.5 | 14.6 | 13.6 |
| LH8 | 22.9 | 23.8 | 24.2 | 16.8 | 17.4 | 18.5 | 16.9 | 13.5 | 14.4 |
| LH9 | 27.8 | 26.6 | 26.3 | 18.3 | 18.2 | 19.4 | 15.7 | 16.6 | 15.7 |
| LH10 | 28.4 | 28.2 | 28.8 | 15.7 | 16.9 | 17.0 | 16.3 | 15.7 | 14.8 |
| LH11 | 23.3 | 24.7 | 24.2 | 19.4 | 18.2 | 16.8 | 13.2 | 12.9 | 14.4 |
| LH12 | 27.0 | 26.5 | 26.3 | 16.5 | 16.9 | 17.3 | 11.4 | 11.6 | 12.7 |
| LH13 | 28.0 | 28.1 | 27.1 | 15.7 | 15.3 | 16.7 | 13.2 | 12.8 | 11.9 |
| LH14 | 31.1 | 29.2 | 29.2 | 14.7 | 15.3 | 15.9 | 14.7 | 12.9 | 14.0 |
| LH15 | 30.6 | 28.5 | 28.8 | 17.2 | 15.7 | 16.5 | 10.2 | 11.8 | 11.9 |
| LH16 | 24.6 | 26.8 | 25.8 | 14.2 | 14.0 | 14.7 | 12.0 | 14.5 | 15.7 |
| LH17 | 28.8 | 27.8 | 28.8 | 12.7 | 14.0 | 15.2 | 11.1 | 14.9 | 14.0 |
| LH18 | 24.5 | 26.1 | 26.3 | 15.3 | 15.3 | 16.6 | 13.0 | 13.9 | 12.7 |
| LH19 | 31.8 | 29.4 | 30.1 | 14.9 | 16.5 | 17.5 | 11.8 | 10.4 | 11.5 |
| LH20 | 27.5 | 29.6 | 28.8 | 18.5 | 17.5 | 16.6 | 14.3 | 12.0 | 13.4 |

Based on the experimental data shown above, Hₘₐₓ, Hₘᵢₙ and H_{avg} were determined as follows. The maximum chamfer Hₘₐₓ was determined as the highest LH, the minimum chamfer height Hₘᵢₙ was determined as the lowest LH, and the average chamfer height H_{avg} was determined as the mean of all local chamfer heights LH determined around the perimeter of the glass article. The results are shown in the following table (in μm).

| | Ex. | Ex. | Ex. | Ex. | Ex. | Ex. | Ex. | Ex. | Ex. |
|---|---|---|---|---|---|---|---|---|---|
| | A1 | A2 | A3 | B1 | B2 | B3 | C1 | C2 | C3 |
| H_{avg} | 27.0 | 26.9 | 26.9 | 16.6 | 16.6 | 17.0 | 13.7 | 13.6 | 13.8 |
| Hₘᵢₙ | 21.9 | 23.8 | 23.7 | 12.7 | 14.0 | 14.7 | 10.2 | 10.4 | 11.5 |
| Hₘₐₓ | 31.8 | 29.6 | 30.1 | 19.4 | 18.6 | 19.4 | 16.9 | 16.7 | 15.7 |

Based on these values TCHV was calculated based on Formula 1. Furthermore, ratio R was calculated based on Formula 2. The results are shown in the following table along with the results of the respective samples in the pendulum swing test represented as critical pendulum angle CPA. Advantageous results were obtained by moving the stack of glass articles relative to the etchant solution during etching. Regarding the thinnest samples (example C) a three dimensional spiral movement of the stack with a speed of 10 mm/s during etching gave the best results (example C3).

| | Ex. A1 | Ex. A2 | Ex. A3 | Ex. B1 | Ex. B2 | Ex. B3 | Ex. C1 | Ex. C2 | Ex. C3 |
|---|---|---|---|---|---|---|---|---|---|
| TCHV | 0.36 | 0.21 | 0.24 | 0.40 | 0.28 | 0.28 | 0.49 | 0.46 | 0.30 |
| R [μm²] | 5187 | 8830 | 7998 | 2070 | 2961 | 3088 | 839 | 877 | 1361 |
| CPA [°] | 60 | 75 | 80 | 35 | 45 | 40 | 20 | 20 | 30 |

There is a dependence of CPA from ratio R as also shown FIG. 3. Notably, the product of thickness t and average chamfer height H_{avg} alone cannot explain the swing pendulum data obtained as shown in FIG. 4. The critical pendulum angle CPA varies remarkably for samples having highly similar values for t*H_{avg}. In contrast, there is a clear correlation of CPA and ratio R because ratio R additionally takes into account the total chamfer height variation TCHV (FIG. 3).

What is claimed is:

1. A chemically toughened glass article, comprising:
a glass having first surface, a second surface, and an edge connecting the first and second surfaces, the first and second surfaces being parallel to each other such that a first tangent line to the first surface has a first angle of 0° and a second tangent line to the second surface has a second angle of 180°;
a thickness between the first and second surfaces of 10 μm to 150 μm;
a first compressive stress region extending from the first surface to a first depth (DoL1), the first compressive stress region having a first compressive stress at the first surface of 100 to 2000 MPa and having a first 60% depth (F60D) defined at a location where a concentration of ions exchanged into the first surface has decreased to 60% as compared to the concentration at the first surface;
a second compressive stress region extending from the second surface to a second depth (DoL2), the second compressive stress region having a second compressive stress at the second surface of from 100 to 2000 MPa and having a second 60% depth (S60D) defined at a location where a concentration of ions exchanged into the second surface has decreased to 60% as compared to the concentration at the second surface;
a central portion having a central thickness equal to t-(F60D+S60D);
a chamfer structure at the edge, the chamfer structure having an averaged chamfer surface with a profile such that an angle (αₓᵢ) of a third tangent line to the averaged chamfer surface at any position on the averaged chamfer surface is in a range of from greater than 0° to less than 180°, wherein the profile is such that for any segment spanning from a first position (xi) to a second position (xj) of the averaged chamfer surface and having an absolute value of a difference of the angles of the third tangent lines at the first and second positions is at least 90°, wherein the profile is such that a projection of the segment onto a line having an angle of 90° with both the first tangent line and the second tangent line has an extent that is at least 25% as compared to the central thickness;
a chamfer height (H) of the chamfer structure that is defined as the projection of the segment spanning from the first surface to the second surface onto a line having an angle of 90° with both the first tangent line and the second tangent line;
a total chamfer height variation (TCHV) of the chamfer height (H) is defined as a difference of a maximum chamfer height (Hₘₐₓ) and a minimum chamfer height (Hₘᵢₙ) along at least a portion of a length of the glass and/or a width of the glass divided by the average chamfer height (H_{avg}) along the portion, wherein the portion is at least 25% of the length and/or the width; and
a first ratio of (t*H_{avg})/TCHV that is at least 250 μm².

2. The article of claim 1, wherein the edge has a breakage swing angle of at least 100 in a pendulum swing test using a stainless steel cylinder having a diameter of 10 mm and a weight of 7.5 g, wherein the swing radius is 20 cm.

3. The article of claim 1, comprising a second ratio of (F60D+S60D)/t that is in a range of from 0.01:1 to 0.5:1.

4. The article of claim 1, comprising a third ratio F60D/S60D that is in a range of from 0.8:1 to 1.2:1.

5. The article of claim 1, comprising an absence of failure when the article is held at a bend radius of 20 mm for 60 minutes.

6. The article of claim 1, wherein the profile is such that the angle (αₓᵢ) of the third tangent line at the first position (xi) is different from the angle (αₓⱼ) of the third tangent line at the second position.

7. The article of claim 1, wherein the average chamfer height (H_{avg}) is from 35% to 100% of the central thickness.

8. The article of claim 1, wherein the total chamfer height variation (TCHV) is at most 0.75.

9. The article of claim 1, wherein the thickness is from 25 μm to 100 μm.

10. The article of claim 1, comprising a forth ratio of the first compressive stress and the second compressive stress in a range of from 0.8:1 to 1.2:1.

11. The article of claim 1, wherein the first surface and/or the second surface has a surface roughness (Rₐ) of at most 1 nm.

12. The article of claim 1, comprising a fifth ratio of the thickness and the average chamfer height (H_{avg}) that is from 1.2:1 to 10:1.

13. The article of claim 1, comprising a product of TCHV and t/H_{avg} that is at most 1.00.

14. The article of claim 1, wherein the glass comprises components (in wt.-%) of:

| Component | Proportion (wt.-%) |
|---|---|
| SiO₂ | 45-75 |
| Al₂O₃ | 2.5-25 |
| Li₂O | 0-10 |
| Na₂O | 5-20 |
| K₂O | 0-10 |
| MgO | 0-15 |
| CaO | 0-10 |
| P₂O₅ | 0-20 |
| BaO | 0-5 |
| ZnO | 0-5 |
| ZrO₂ | 0-5 |
| B₂O₃ | 0-5 |
| TiO₂ | 0-2.5. |

15. The article of claim 1, comprising a further material attached to a surface of the chamfer structure, the further material covering from at least 50% to 100% of the surface of the chamfer structure.

16. The article of claim 15, wherein the further material covers at least 0.1% and at most 100% of the first surface and/or the second surface.

17. The article of claim 15, wherein the further material has a Young's modulus selected from a group consisting of: at most 10 GPa, at most 7 GPa, at most 6 GPa, at most 5 GPa, at most 4 GPa, at most 3 GPa, at most 2 GPa, or at least 100 kPa, at least 200 kPa, at least 300 kPa, at least 400 kPa, at least 500 kPa, and combinations thereof.

18. The article of claim 15, wherein the further material is a polymer selected from a group consisting of Parylene, thermoplastic polyurethane (TPU), polycarbonate (PC), polyethylene (PE), polypropylene (PP), polysulfone (PS), polyethersulfone (PES), polyetheretherketone (PEEK), polyamide (PA), polyamideimide (PAI), polyimide (PI), poly(methyl methacrylate) (PMMA), polyimethylsiloxane (PDMS), polytetrafluoroethylene (PTFE), elastomer, inorganic-organic hybrid polymer material, a polysiloxane, PMMA with inorganic nanoparticles, epoxy-siloxane hybrids, and any combinations thereof.

19. The article of claim 1, wherein the article is configured for a use selected from the group consisting of a substrate of a display, a cover of a display, a sensor, a fingerprint sensor module, a thin film battery, a semiconductor package, and a foldable display.

20. A method of producing a chemically toughened glass article, comprising:
providing a glass article first surface, a second surface, and an edge connecting the first and second surfaces, the first and second surfaces being parallel to each other and having a thickness between the first and second surfaces of 10 μm to 150 μm;
providing a chamfer structure to the edge; and
chemically toughening the glass article to provide:
a first compressive stress region extending from the first surface to a first depth (DoL1), the first compressive stress region having a first compressive stress at the first surface of 100 to 2000 MPa and having a first 60% depth (F60D) defined at a location where a concentration of ions exchanged into the first surface has decreased to 60% as compared to the concentration at the first surface,
a second compressive stress region extending from the second surface to a second depth (DoL2), the second compressive stress region having a second compressive stress at the second surface of from 100 to 2000 MPa and having a second 60% depth (S60D) defined at a location where a concentration of ions exchanged into the second surface has decreased to 60% as compared to the concentration at the second surface, and
a central portion having a central thickness equal to t-(F60D+S60D).
